(19) United States
(12) Patent Application Publication
(10) Pub. No.: US 2010/0212458 A1
(43) Pub. Date: Aug. 26, 2010

(54) BOTTLE OPENER RING

(75) Inventors: Mark Peter Wegener, Sacramento, CA (US); Wendi Lee Wegener, Sacramento, CA (US); Amy Jennifer Guthrie, Sacramento, CA (US)

Correspondence Address: JOHN P. O'BANION;O'BANION & RITCHEY LLP, 400 CAPITOL MALL SUITE 1550, SACRAMENTO, CA, 95814, US

(73) Assignee: SUDZ, INC., Sacramento, CA (US)

(21) Appl. No.: 12/701,502

(22) Filed: Feb. 5, 2010

Related U.S. Application Data
(60) Provisional application No. 61/150,065, filed on Feb. 5, 2009.

(51) Int. Cl. B67B 7/16

(52) U.S. Cl. 81/3.09; 81/3.55

(57) ABSTRACT

A finger or thumb ring bottle opener with a continuous band with a tab defined by a pair of notches located at the back of the ring and the tab does not extend beyond the top, bottom or exterior surfaces of the ring. In use, the ring is placed on the finger of the user with the tab facing the fingertips and is positioned on a bottle cap so that the tab engages the bottom portion of the skirt of the bottle cap and a portion of the cap is in the notches of the ring. Forward and upward force applied to the ring through the finger causes the cap to separate from the bottle. In one embodiment, a platform is disposed on the front of the ring for promotional indicia or ornamentation.

### CROSS-REFERENCE TO RELATED APPLICATIONS

This application claims priority from U.S. provisional application Ser. No. 61/150,065 filed on Feb. 5, 2009, incorporated herein by reference in its entirety.

This application is also related to U.S. design patent application Ser. No. 29/355,390 filed on Feb. 5, 2010, incorporated herein by reference in its entirety, and to U.S. design patent application Ser. No. 29/355,391 filed on Feb. 5, 2010, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to manual bottle cap removal devices, and more particularly to a ring worn by the user that is capable of opening bottles or tab topped containers and that is also suitable for advertising and promotional use.

2. Description of Related Art

Glass beverage containers are desirable because glass does not react with acids, alcohols or other beverage constituents. Although glass is transparent permitting easy viewing of the contents, glass containers may be formed from colored glass that limits the exposure of the beverage to light. Sealed glass bottles are also capable of preserving or maintaining beverages during long storage periods or periods of fermentation.

Beverage container designs typically include a neck with a circular opening that has a rounded circumferential edge. The bottle opening is typically sealed and secured with a metal disc that is placed over the bottle opening and the edges are folded and crimped around the rounded edge of the bottle opening at a bottling plant. Crimped metal caps are also known as crown caps and they provide a durable sealed closure for the bottle. Sealed bottles are then shipped to grocery stores, restaurants, bars, warehouses and other points of distribution to the public.

Removal of the standard crimped metal caps from a bottle to gain access to the liquid contents requires a specialized tool or opener. Bottle openers of many different designs have been developed that are used to pry the crimped caps from the opening of the bottle and provide some mechanical advantage. Bottle openers known in the art may be fixed to walls, soft drink dispensing machines or other permanent structures. Portable bottle openers are particularly desirable due to the universal availability of single serving glass bottles with crimped caps or metal twist caps that can be consumed in boats and other vehicles or taken to remote outdoor locations. A portable bottle opener is a necessity in these outdoor settings as well as in indoor settings where bottled beverages are served.

There have been many different bottle opening devices that have been developed since the crown cap became the standard for beverage containers. Many of the openers that have been developed in the art are compact enough to be carried in a pocket or as part of a key chain. Conventional bottle opening designs have an elongate handle with a head mounted to one end. The head typically has an opening with a straight edge that engages the top of the cap and has a tooth on the handle side of the opening that engages the bottom edge of the crimped cap. Lifting of the handle up and away from the bottle with the established fulcrum causes the opener to pivot around the straight edge of the head and the tooth to force the edge of the cap up and the cap to deform and separate from the opening of the bottle. The length of the handle increases the lever arm and mechanical advantage of the opener.

The second conventional crimped metal bottle cap applied to a beverage bottle is the twist-off cap. The outside edge of the outer circumference of the opening of the bottle is threaded so that rotation of the crimped metal cap by the user will engage the threads and raise the cap away from the bottle. However, twist-off caps are often secured so tightly to the container that it is difficult to remove even for a person that is capable of applying substantial torque on the cap. Elderly people or persons that are not able to grasp the cap and apply sufficient rotational force on the cap without experiencing pain will need to use a tool to remove the cap.

One significant difficulty of the crimped metal cap system is that access to the contents of the bottle must be through the use of an opener. Bringing the opener and bottle together may be time consuming. It is often necessary for a consumer to search for a bottle opener or postpone access to the contents of the bottle to another time. The availability of an opener and the search time may be particularly important in a service setting such as in restaurants, hospitals, bars or other business establishments. Patrons may be required to wait until a suitable opener can be located. Convenience store purchases could also be limited if the patrons do not have access to a bottle opener. The search for a bottle opener can be particularly annoying when attempting to open a bottle at remote locations.

Unfortunately bottle openers known in the art are easily lost, borrowed, misplaced or forgotten when they are not in use. One contributing factor to this phenomenon is the size and weight of existing openers that make them inconvenient to carry in a pocket or to store.

Accordingly, there is a need for a container opener that can open crimped caps or twist-on caps and flip top cans that is easy to use and can be comfortably retained by the user and available for use at any time an opener is needed. There is also a need for a bottle opener that can be easily and inconspicuously transported and is readily accessible for use and will not get lost or misplaced. The present invention satisfies these needs as well as others and is generally an improvement over the art.

### BRIEF SUMMARY OF THE INVENTION

The present invention is an apparatus for efficiently removing crimped metal caps, twist-on metal caps as well as opening tab-top or flip-top containers that is continuously worn by the user. The present invention generally provides jewelry that has utility other than for ornamentation. More particularly, the invention provides a ring-bottle opener combination that permits the wearer to open a beer or soda bottle with without the need for searching for an opener because it is worn on the finger or thumb of the user.

By way of example and not of limitation, one embodiment of the apparatus of the present invention generally comprises a ring body that is sized to fit on the finger or thumb of a user. The back side of the ring body has a cap engaging tab that is formed by a pair of angled notches in the ring body. The placement of the tab on the underside of the ring conceals the fact that the ring has a bottle opener function. The bottle opener does not interfere with the normal movements of the hand and is comfortable to wear because the tab does not extend beyond the normal dimensions of the ring. The notches that form the tab are preferably wider than they are deep. The width of the tab is preferably sized to fit underneath approximately two indentations in the skirt of a crimped bottle cap in one embodiment. The tab may also have a beveled leading edge to assist with placement.

The ring may be ornamented with metals or stones or other materials that typically used for jewelry. In one embodiment, the ring has a platform on the front of the ring in a variety of shapes that can be used for engraving or for the application of logo's, insignia's, trademarks or other advertising so that the ring opener can be used as a promotional item. For example, the platform can include school or organizational indicia such as with college or professional sports team logos or business names. The platform could also include beverage trademarks and be used by beverage producers to advertise and promote consumption of their beverages. The ring is not only used as a bottle opener but can be used as an advertising tool or organization promotional item as well.

The ring can be manufactured from many different types of materials that can form a ring with rigid tab such as stainless steel or aluminum. For example, steel rings can be made and electroplated with precious metals to make them corrosion resistant as well as attractive.

In use, the ring is placed on the finger or thumb of the hand of the user with the tab facing the finger tips. The tab of the ring that is worn by the user is placed in the space between the cap and the bottle and engages the edge of the skirt of the cap facilitated by the notches on either side of the tab. The ring with the placed tab is brought forward so that the edges of the ring on either side of the tab engage the side walls of the cap creating a pivot point or fulcrum point. Force applied to the lever arm provided by the ring body will cause the cap edge to move away from the bottle and separate and an upward force applied to the ring will pull the cap upward and away from the bottle opening. The removal of the cap can be performed with a simple forward and upward motion once the tab is engaged with the cap.

According to one aspect of the invention, an apparatus for removing bottle caps is provided that permits the user to have immediate access to the opener because it is worn continuously as a ring thereby eliminating the amount of time required to find and use a conventional bottle opener.

According to another aspect of the invention, a tool for removing bottle caps is provided that also functions as an advertising or promotional tool.

A further aspect of the invention is to provide a ring that is unique and stylish and can be worn without calling attention to its utility as a bottle opener.

Another aspect of the present invention is to provide a tool that can be comfortably worn and easily used by the operator for removing bottle caps that is attractive in appearance.

A further aspect of the invention is to provide a tool which permits the removal of a cap with a relatively small application of force.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWINGS

The invention will be more fully understood by reference to the following drawings which are for illustrative purposes only:

FIG. 1 is a perspective top down view of one embodiment of the bottle opener ring apparatus according to the invention.

FIG. 2 is a front plan view of the ring embodiment of the invention shown in FIG. 1.

FIG. 3 is a back plan view of the ring embodiment of the invention shown in FIG. 1.

FIG. 4 is a top plan view of the ring embodiment of the invention shown in FIG. 1.

FIG. 5 is a bottom plan view of the ring embodiment of the invention shown in FIG. 1.

FIG. 6 is a right side view of the ring embodiment shown in FIG. 1 and the left side of the ring is a mirror image along the plane shown in FIG. 5.

FIG. 7 is a detailed view of one embodiment of the notch and tab portions of the ring embodiment of the invention shown in FIG. 6.

FIG. 8 is a side view of a ring bottle opener engaging the skirt of a metal bottle cap during use according to the invention.

FIG. 9 is a detailed view of the engagement of the ring with the skirt of the bottle cap shown in FIG. 8.

FIG. 10A and FIG. 10B shows the ring opener of FIG. 1 in use at the beginning and end of the cap removal procedure according to the invention.

### DETAILED DESCRIPTION OF THE INVENTION

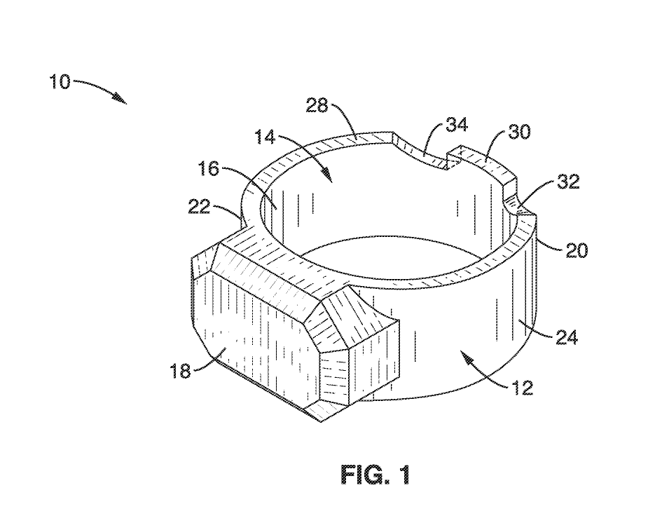

Referring more specifically to the drawings, for illustrative purposes the present invention is embodied in the apparatus generally shown in FIG. 1 through FIG. 10B. It will be appreciated that the apparatus may vary as to configuration and as to details of the parts, and that the methods of use may vary as to the specific steps and sequence, without departing from the basic concepts as disclosed herein.

Referring first to FIG. 1 through FIG. 7, one embodiment of the ring bottle opener apparatus invention 10 is generally shown. The apparatus 10 has a ring body 12 with a central bore 14 that is selectively sized to accommodate the finger or thumb of the user within the interior 16 of the central bore 14. In the embodiment shown in FIG. 1 though FIG. 7, the ring has a planer front surface 18, a back section 20, a left side section 22, a right side section 24, a top surface 26 and a bottom surface 28. Although the embodiment of the apparatus 10 used to illustrate the invention has a front 18, it will be understood that the front surface is optional and could be any size or shape or could be absent so that the ring 10 has a perfectly circular cross section.

The back section 20 of the ring apparatus 10 has a tab 30 that is formed from a right notch 32 and a left notch 34 on the bottom side 28 in the back section 20 of the ring 10. The right notch 32 is preferably the mirror image of the left notch 34 taken along axis 36 shown in FIG. 5. The dimensions of notch 32 and notch 34 are preferably wider than they are deep. In other words, the width of the notch is preferably greater than the length of the sides of tab 30. The angle of the notches can also change accordingly.

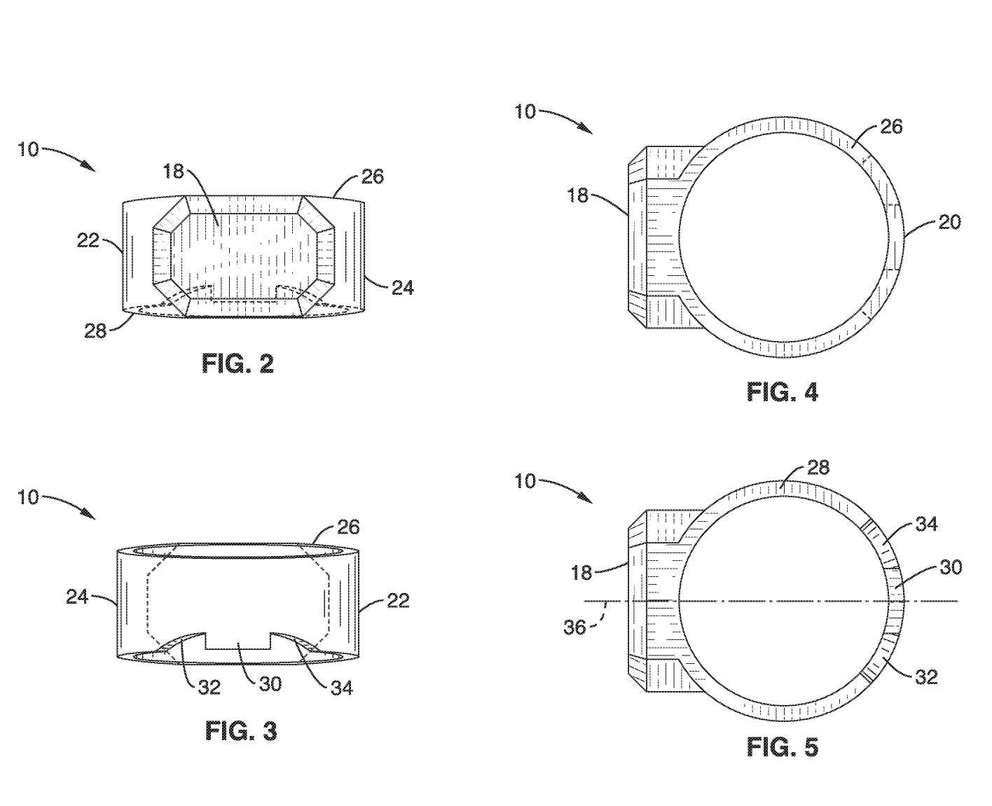

The front surface 18 can be seen in the front view of FIG. 2 having an elongated geometric shape at the front portion of the ring. Although an elongate planer shape is shown in this embodiment, many different two and three dimensional shapes may be used such as ovals, rectangles and squares or may be ornamented with precious stones, metals, engravings or other design features.

In one preferred embodiment, the front surface 18 is used as a platform for promotional advertising. For example, the front surface 18 could contain the logo, trademark or other insignia of a company for promotional purposes. Advertisements promoting beverage manufacturing companies, professional sports teams, insurance companies, businesses and associations could be applied to any part of the ring, but preferably on the front surface 18 of the ring. Distribution of rings 10 with advertising on front surface 18, for example, can lead to an increase in the name recognition of the businesses when distributed and used as promotional items. The surface 18 may alternatively be engraved with initials of the owner or with other meaningful symbols such as university emblems or association or club symbols.

The back and bottom views shown in FIG. 3 and FIG. 5 illustrate the bottle opener functionality of the ring apparatus 10. As seen in FIG. 3, the tab 30 is defined by right notch 32 and left notch 34 with substantially vertical edges forming the tab 30. Although it is preferred that the tab 30 have vertical edges, the edges of tab 30 need not be vertical and could be tapered.

It can be seen that tab 30 does not extend beyond the level of bottom 28 and is not observable during the normal wearing of the ring with the palm down or when the fingers are articulated or formed into a fist. The tab 30 does not interfere with the movements of the fingers or thumb when worn by the user or during use.

The tab 30 is placed on the underside of the ring 10 so that it conceals the fact that the ring is a bottle cap opener while it is being worn. Additionally, the placement of the tab 30 at the rear section 20 of the ring 10 is necessary so that the wearer can lift the bottle cap off of the bottle without turning the ring around the finger to use. Having the tab located at a different location on the ring than the back would limit or prohibit the necessary leverage needed for the tab 30 to function properly.

In one illustrative embodiment, the width of the tab 30 is approximately one quarter (¼″) of an inch with edges approximately one sixteenth ( 1/16″) of an inch in height. Therefore the two notches 32, 34 on either side of the tab 30 measure 1/16″ in depth at the edges of tab 30 and are preferably about one quarter (¼″) of an inch in width.

In another embodiment, the top edge of the tab 30 that lays flush against the skin is optionally beveled with an approximately 30 degree angle to approximately a 45 degree angle. The bevel can be in either direction. This edge of tab 30 engages the crimped edge of the metal cap 44 between the cap and the bottle 42.

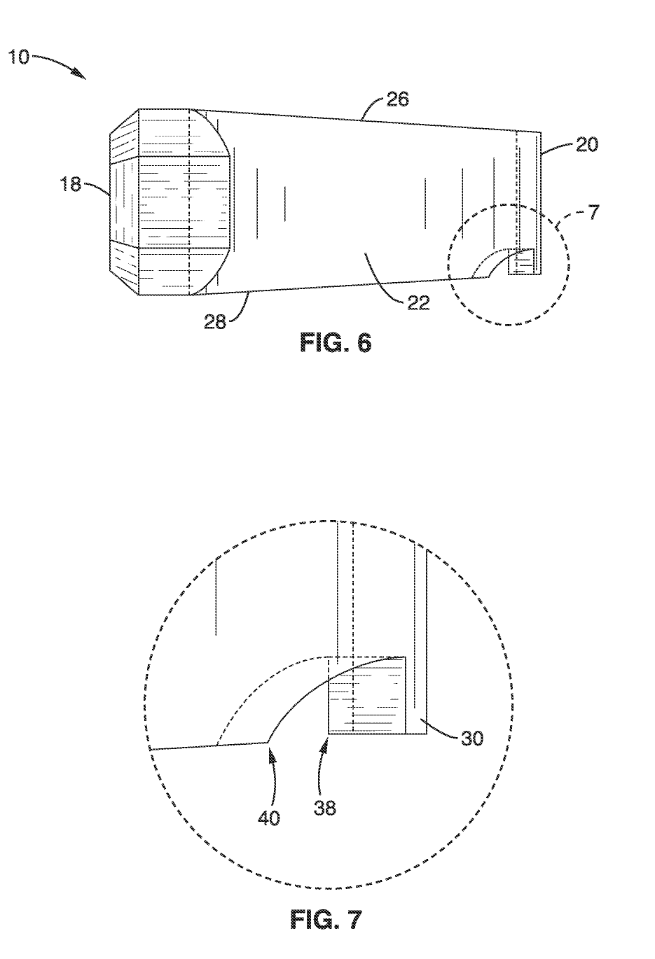

Turning now to FIG. 6 through FIG. 10B, the function of the tab 30 and notches 32, 34 for removing a metal cap 44 from a bottle 42 is generally shown. As seen in FIG. 6 and FIG. 7, the position of notch 32 and notch 34 in the arcuate walls of the ring 10 creates a space between the edge 38 of tab 30 and edge 40 of notch 32 when viewed from the side. A similar edge and spacing is produced on the left side with notch 34 and tab 30. Accordingly, the width of notch 32 and notch 34 and the width of tab 30 can be manipulated to change the configuration of the space. The diameter of the ring will also influence this spacing. As seen in FIG. 9, the skirt of cap 44 is positioned into the space and edge point 38 of tab 30 and the edge point 40 of the notches 32, 34 of the ring 10 engage the metal cap 40 during use.

The ring opener is preferably configured and sized to engage the standard sized crimped crown cap or twist cap. In the preferred configuration, the tab 30 is sized to fit underneath approximately two of the indentations on the skirt of a conventional bottle cap. However, the apparatus can be adapted for use on caps and bottle openings of various non-standard sizes.

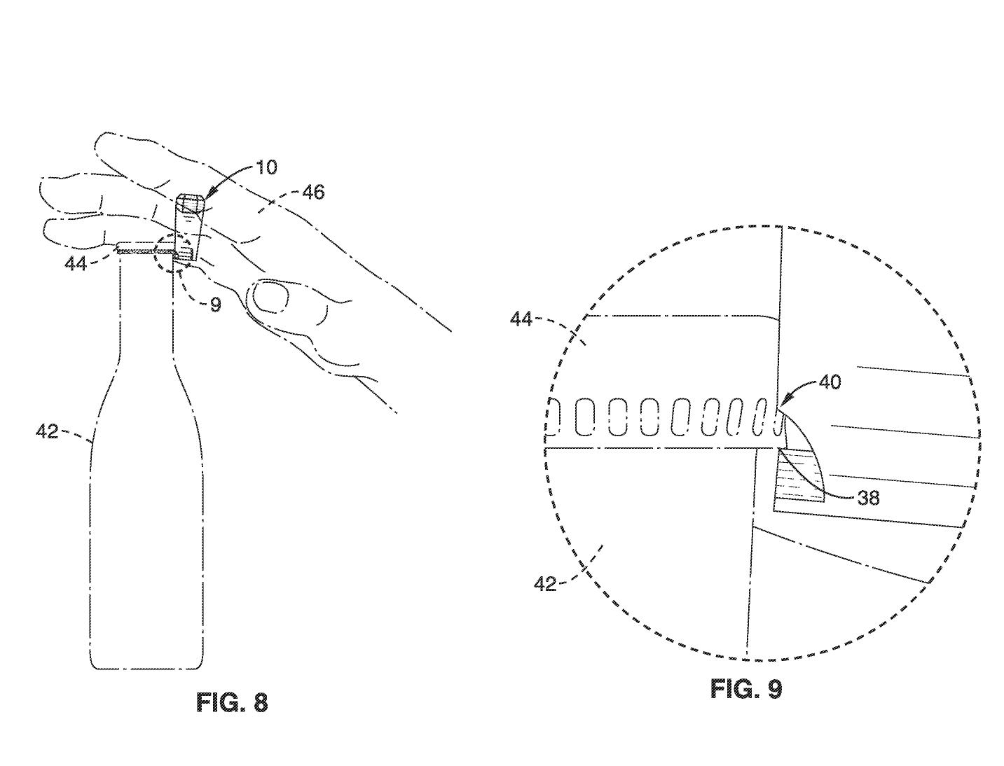

Referring now to FIG. 8 through FIG. 10B, the bottle cap removing function of the ring 10 is shown. In use, the wearer places the ring on their finger with the tab side or bottom 28 facing away from their body (the tab 30 should be pointing in the direction of their fingertip). The ring 10 has been placed on the ring finger of hand 46 in the illustration shown in FIG. 8 through FIG. 10B. However, the ring 10 can be placed on the thumb or other fingers and function properly.

As seen in FIG. 8 and FIG. 9, the user would then place their hand 46 over the bottle cap 44 and slide the tab 30 of the ring 10 underneath two of the indentations on the cap 44. The points of engagement 34 of the tab 30 and of the edge of notch 38 of the ring are shown in detail in FIG. 9. With the edge 38 of tab 30 engaged with the skirt edge of cap 44, preferably in the space between the bottle lip and the crimped edge of cap 44, a fulcrum is created when the ring is rotated toward the cap 44 and the engagement point 40 contacts the outer edge of cap 44. A similar engagement point is found on the other side of the tab 30 to provide at least two fulcrum points with the balance of ring body providing the lever arm. Force can be applied to the ring that is thus engaged with the cap 44 to pull the skirt edge of cap 44 away from the bottle 42 thereby breaking the seal of the cap on the opening of the bottle 42. Although removal of the cap 44 usually takes place in a single in a single event, tab 30 can be placed at different locations around the circumference of the cap and force applied so that skirt is separated at several locations before the cap is removed.

It can be seen that the functionality of ring 10 can be applied to other types of bottle caps to loosen and remove the caps. For example, large jar lids that are removed by rotation around threads on the outside of the jar are often difficult to remove for the first time. The mechanical advantage provided by ring 10 can be used to loosen the lid by placing tab 30 between the lid edge and the jar and slightly separating the lid from the jar to break the seal.

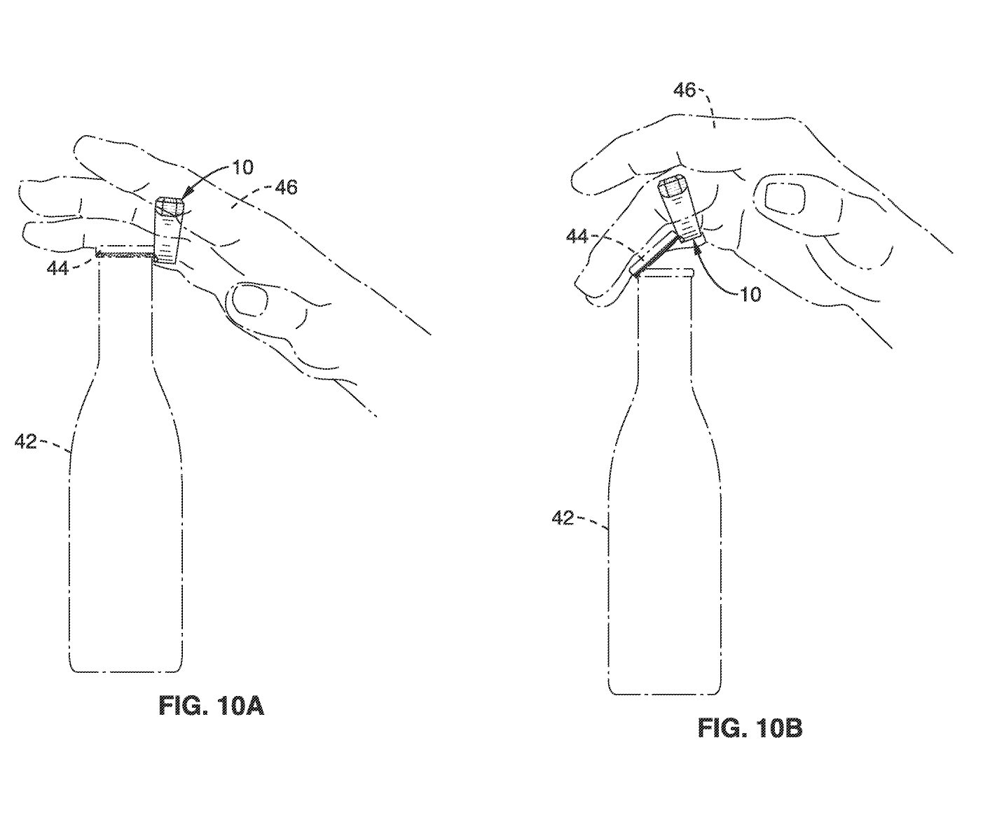

FIG. 10A and FIG. 10B illustrate the use of the ring 10 on a conventional beverage bottle 42. Tab 30 of ring 10 engages the cap 44 as shown in detail in FIG. 9. Holding the bottle 42 steady with the free hand, the user would then lift their hand 46 (the hand wearing the ring) up and forward angled slightly away from the user. With a very small amount of force, the cap edge is separated and cap 44 is lifted from the top of the bottle 42 and completely removed as seen in FIG. 10B.

Similarly, tab 26 can also be used to engage the pull tab of a beverage can that is then lifted upwardly to open the can. This can help avoid injury to fingernails and fingers pop-top cans.

From the discussion above it will be appreciated that the invention can be embodied in various ways, including the following:

1. An apparatus for removing a container closure, comprising a continuous ring body with a central bore sized to receive a digit of a user, the ring body having an outer surface, a top, a bottom, a front section and a rear section; and a tab defined by a first notch and a second notch in said rear section of said ring body; wherein the tab does not extend beyond the outer surface, the top or the bottom of said ring body.

2. An apparatus according to embodiment 1, further comprising a planar platform disposed on the front section of the ring body with a plane oriented perpendicularly to the axis of the central bore.

3. An apparatus according to embodiment 2, further comprising promotional indicia mounted to the planar platform on the front section of the ring body.

4. An apparatus according to embodiment 3, wherein the promotional indicia is selected from the group promotional indicia consisting essentially of a professional sports team logo, a college indicator, a beverage manufacturer logo, a trademark, and an engraving.

5. An apparatus according to embodiment 2, wherein the planar platform has a shape selected from the group of shapes consisting essentially of an oval shape, a rectangular shape, a circular shape and a hexagonal shape.

6. An apparatus according to embodiment 1, wherein the tab further comprises a beveled edge.

7. An apparatus according to embodiment 1, wherein the first notch and the second notch have the shape of a right triangle.

8. An apparatus according to claim 1, wherein a length of a side of said tab is approximately half the size of a width of the first notch or the second notch.

9. An apparatus for removing a container closure, comprising a continuous ring body with a central bore sized to receive a digit of a user, the ring body having an outer surface, a top, a bottom, a front section and a rear section; a planar platform disposed on said front section of the ring body with a plane oriented perpendicularly to an axis of the central bore; and a tab defined by a first notch and a second notch in the rear section of the ring body for engaging a bottle cap; wherein said tab does not extend beyond the outer surface, the top or the bottom of the ring body.

10. An apparatus according to embodiment 9, further comprising promotional indicia mounted to the planar platform on the front section of the ring body.

11. An apparatus according to embodiment 10, wherein the promotional indicia is selected from the group promotional indicia consisting essentially of a professional sports team logo, a college indicator, a beverage manufacturer logo, a trademark, and an engraving.

12. An apparatus according to embodiment 9, wherein the planar platform has a shape selected from the group of shapes consisting essentially of an oval shape, a rectangular shape, a circular shape and a hexagonal shape.

13. An apparatus according to embodiment 9, wherein the tab further comprises a beveled edge.

14.An apparatus according to embodiment 9, wherein the first notch and said second notch have the shape of a right triangle.

15. An apparatus according to embodiment 9, wherein the length of a side of the tab is approximately half the size of the width of the first notch or the second notch.

16. An apparatus for removing a container closure, comprising a continuous ring body with a central bore sized to receive a digit of a user, the ring body having an outer surface, a top, a bottom, a front section and a rear section; a planar platform disposed on the front section of the ring body with a plane oriented perpendicularly to the axis of the central bore; and a tab defined by a first notch and a second notch in the rear section of the ring body, the tab having vertical side walls and a beveled horizontal edge;
wherein the tab does not extend beyond the outer surface, the top or the bottom of the ring body.

17. An apparatus according to embodiment 16, further comprising promotional indicia mounted to the planar platform on the front section of the ring body.

18. An apparatus according to embodiment 16, wherein the promotional indicia is selected from the group promotional indicia consisting essentially of a professional sports team logo, a college indicator, a beverage manufacturer logo, a trademark, and an engraving.

19. An apparatus according to embodiment 16, wherein the width of the first notch or the second notch is at least twice the length of the vertical side walls of the tab.

20. An apparatus according to embodiment 16, wherein the width of the tab is approximately equal to the distance between two corrugations on the skirt of a bottle cap.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for removing a container closure, comprising:
a continuous ring body with a central bore sized to receive a digit of a user, the ring body having an outer surface, a top, a bottom, a front section and a rear section; and
a tab defined by a first notch and a second notch in said rear section of said ring body;
wherein said tab does not extend beyond the outer surface, the top or the bottom of said ring body.

2. An apparatus as recited in claim 1, further comprising:
a planar platform disposed on said front section of the ring body with a plane oriented perpendicularly to an axis of said central bore.

3. An apparatus as recited in claim 2, further comprising:
promotional indicia mounted to said planar platform on said front section of the ring body.

4. An apparatus as recited in claim 3, wherein said promotional indicia is selected from the group promotional indicia consisting essentially of a professional sports team logo, a college indicator, a beverage manufacturer logo, a trademark, and an engraving.

5. An apparatus as recited in claim 2, wherein said planar platform has a shape selected from the group of shapes consisting essentially of an oval shape, a rectangular shape, a circular shape and a hexagonal shape.

6. An apparatus as recited in claim 1, wherein said tab further comprises a beveled edge.

7. An apparatus as recited in claim 1, wherein said first notch and said second notch have the shape of a right triangle.

8. An apparatus as recited in claim 1, wherein a length of a side of said tab is approximately half the size of a width of said first notch or said second notch.

9. An apparatus for removing a container closure, comprising:
a continuous ring body with a central bore sized to receive a digit of a user, the ring body having an outer surface, a top, a bottom, a front section and a rear section;
a planar platform disposed on said front section of the ring body with a plane oriented perpendicularly to an axis of said central bore; and
a tab defined by a first notch and a second notch in said rear section of said ring body for engaging a bottle cap;
wherein said tab does not extend beyond the outer surface, the top or the bottom of said ring body.

10. An apparatus as recited in claim 9, further comprising:
promotional indicia mounted to said planar platform on said front section of the ring body.

11. An apparatus as recited in claim 10, wherein said promotional indicia is selected from the group promotional indicia consisting essentially of a professional sports team logo, a college indicator, a beverage manufacturer logo, a trademark, and an engraving.

12. An apparatus as recited in claim 9, wherein said planar platform has a shape selected from the group of shapes consisting essentially of an oval shape, a rectangular shape, a circular shape and a hexagonal shape.

13. An apparatus as recited in claim 9, wherein said tab further comprises a beveled edge.

14. An apparatus as recited in claim 9, wherein said first notch and said second notch have the shape of a right triangle.

15. An apparatus as recited in claim 9, wherein a length of a side of said tab is approximately half the size of a width of said first notch or said second notch.

16. An apparatus for removing a container closure, comprising:
a continuous ring body with a central bore sized to receive a digit of a user, the ring body having an outer surface, a top, a bottom, a front section and a rear section;
a planar platform disposed on said front section of the ring body with a plane oriented perpendicularly to an axis of said central bore; and
a tab defined by a first notch and a second notch in said rear section of said ring body, said tab having vertical side walls and a beveled horizontal edge;
wherein said tab does not extend beyond the outer surface, the top or the bottom of said ring body.

17. An apparatus as recited in claim 16, further comprising:
promotional indicia mounted to said planar platform on said front section of the ring body.

18. An apparatus as recited in claim 16, wherein said promotional indicia is selected from the group promotional indicia consisting essentially of a professional sports team logo, a college indicator, a beverage manufacturer logo, a trademark, and an engraving.

19. An apparatus as recited in claim 16, wherein a width of said first notch or said second notch is at least twice the length of said vertical side walls of said tab.

20. An apparatus as recited in claim 16, wherein a width of said tab is approximately equal to the distance between two corrugations on a skirt of a bottle cap.
